(19) United States
(12) Patent Application Publication
(10) Pub. No.: US 2013/0279653 A1
(43) Pub. Date: Oct. 24, 2013

(54) METHODS AND APPARATUS FOR X-RAY DIFFRACTION

(71) Applicant: Graeme Mark Hansford, Leicester (GB)

(72) Inventor: Graeme Mark Hansford, Leicester (GB)

(21) Appl. No.: 13/451,019

(22) Filed: Apr. 19, 2012

(51) Int. Cl. G01N 23/207; G01N 23/223

(52) U.S. Cl. 378/46; 378/73

(57) ABSTRACT

Methods and apparatus are provided for performing back-reflection energy-dispersive X-ray diffraction (XRD). This exhibits extremely low sensitivity to the morphology of the sample under investigation. As a consequence of this insensitivity, unprepared samples can be analyzed using this method. For example, in a geological context, whole rock samples become amenable to analysis. Modifications of the technique are described to suppress fluorescence signals that would otherwise obscure the diffraction signals.

### FIELD The present invention relates generally to methods and apparatus for X-ray diffraction (XRD).

### BACKGROUND

Powder X-ray diffraction (XRD) is a well-known technique for analysis of crystalline materials. Powder XRD methods are usually applied in an angle-dispersive mode (ADXRD). In ADXRD, an X-ray beam with, ideally, a single wavelength λ is diffracted by a sample through a range of distinct scattering angles 20, according to the Bragg equation:

λ=2d sinθ (1)

The sample is powdered, so that the crystallites within the beam can generally be assumed to be randomly oriented in all directions. The derived set of crystal d-spacings, uniquely characteristic of each mineral phase, is used for phase identification, quantification and structural analysis, amongst other purposes. Energy-dispersive X-ray diffraction (EDXRD) is an alternative application of the Bragg equation. In EDXRD one fixes the scattering angle and scans the X-ray wavelength (equivalently, the X-ray energy). This method can also be implemented without scanning the X-ray wavelength: a broadband X-ray source, such as an X-ray tube, can be used together with an energy-resolving detector.

Both ADXRD and EDXRD have their particular benefits and drawbacks, and find application in different fields. In both techniques, however, X-ray diffraction is sensitive to the morphology of the sample under investigation. As a consequence of this sensitivity, it is difficult to analyze unprepared samples using the conventional techniques. For example, in a geological context, it is difficult to analyze whole rock samples. Rather, a uniform presentation of samples in powder form is required. Therefore the known techniques have limitations on their application, particularly in the field. Samples that are precious and must not be damaged, for example some archaeological artifacts, present difficulties to the powder XRD techniques, for obvious reasons.

### SUMMARY

In a first aspect, the invention provides a method of inspecting a material sample by X-ray diffraction wherein the sample is irradiated with a beam of X-ray radiation from a source with a range of photon energies, and wherein at least one energy-resolved spectrum is obtained from radiation diffracted substantially back toward the source.

Said energy-resolved spectrum may be processed to obtain information on the spacing of crystal planes in said sample, said information being substantially independent of sample distance or morphology.

The invention provides X-ray diffraction based on energy-dispersive or wavelength-dispersive XRD and using a diffraction angle of substantially 180°. The use of this extreme angle, effectively back-reflection toward the source, helps to make the diffraction spectrum largely insensitive to sample distance or morphology. Therefore useful measurements can be obtained with non-prepared samples such as rocks in their natural form. The use of back-reflection and a fixed angle allows a compact and robust construction of instrument, which may be portable and even hand-held. The instrument can be operated with source and detector closer to the sample than most prior instruments, leading to improved signal strength.

In a particular embodiment plurality of energy-resolved spectra are obtained using different settings of source energy, whereby at least one of said spectra excludes a fluorescence signal that is present in another of said spectra. Said plurality of spectra may be processed together to obtain information on the spacing of crystal planes in the sample over a wider range of spacings than can be obtained from any one of the spectra on its own.

The invention in another aspect provides an apparatus for use in performing back-reflection energy-dispersive X-ray diffraction to determine characteristics of a material sample, the apparatus comprising:

a source arrangement for irradiating said sample with a beam of radiation at X-ray wavelengths;

a detector for detecting diffracted radiation returning from a sample in a direction substantially back towards said source; and

a processor for resolving the detected radiation into a spectrum of wavelengths.

In one embodiment, said source arrangement is located behind said detector, such that said beam of radiation passes beside or through said detector to reach said sample. The detector may substantially or completely surround a path of said beam.

The source arrangement comprises a source of X-ray radiation may be controllable to restrict the maximum photon energy of radiation to different selected values. This allows diffraction peaks to be identified independently of fluorescence signals that would otherwise obscure them. The apparatus may include a controller for automatically controlling said source and said detector to record a plurality of spectra using different maximum photon energies. The apparatus may further comprise a processor for processing said plurality of spectra to obtain from one of said spectra information of diffraction peaks that are obscured by fluorescence signals in another of said spectra.

In another aspect, the invention provides a method of X-ray diffraction analysis by detecting spectral characteristics of radiation diffracted by a range of angles close to 180°.

The above and other aspects, features and advantages of the invention will be understood by the skilled reader from a consideration of the following detailed description of exemplary embodiments.

### BRIEF DESCRIPTION OF THE DRAWINGS

Embodiments of the invention will now be described, by way of example only, with reference to the accompanying schematic drawings in which:

FIG. 1 is a schematic diagram of a novel apparatus for performing back-reflection energy-dispersive X-ray diffraction (BR-EDXRD) according to an embodiment of the present invention;

FIG. 2 illustrates a simulation of the spectrum of a mineral sample in a first method employing the apparatus of FIG. 1;

FIG. 3 illustrates simulated spectra of a mineral sample in a second method employing the apparatus of FIG. 1;

FIG. 4 illustrates back-reflection EDXRD spectra of a conventional powder sample in three different positions;

FIG. 5 illustrates a back-reflection EDXRD spectrum of a conventional pressed-powder sample compared to the spectrum of a whole rock sample; and

FIG. 6 is a flowchart of a method employing the apparatus of FIG. 1

### DETAILED DESCRIPTION OF EXEMPLARY EMBODIMENTS

We describe herein a novel method in the field of X-ray diffraction (XRD) which exhibits extremely low sensitivity to the morphology of the sample under investigation. As a consequence of this insensitivity, unprepared samples can be analyzed using this method. For example, in a geological context, whole rock samples become amenable to analysis. The fundamental principles of the technique and its experimental validation are explained in detail in an article by the present inventor, namely G. M. Hansford, “Back-Reflection Energy-Dispersive X-Ray Diffraction: A Novel Diffraction Technique with Almost Complete Insensitivity to Sample Morphology”, J. Appl. Cryst., 44, 514-525 (2011) [Reference 1].This paper was first made available to the public on 22 Apr. 2011. Its contents are herby incorporated by reference.

As mentioned in the introduction, powder XRD methods are usually applied in an angle-dispersive mode, whereby an X-ray beam with, ideally, a single wavelength λ is diffracted through a range of distinct scattering angles 20 according to the Bragg equation:

λ=2d sinθ (1)

For a microcrystalline sample, peaks in the intensity of diffracted radiation are observed at specific angles, each corresponding to a different spacing d of planes in the crystal structure. The derived set of crystal d-spacings, uniquely characteristic of each mineral phase, is used for phase identification, quantification and structural analysis, amongst other purposes. In energy-dispersive X-ray diffraction (EDXRD), which is the basis of the present invention, one fixes the scattering angle and scans the X-ray wavelength (equivalently, the X-ray energy). This method can also be implemented without scanning the X-ray wavelength: a broadband X-ray source, such as an X-ray tube, can be used together with an energy-resolving detector. In either case, peaks in the intensity of diffracted radiation are observed at specific energy (wavelength) values in the spectrum of energies detected by the detector. Energy in this context refers to the photon energy (corresponding to the frequency or wavelength of the radiation), rather than the intensity of radiation at the specific energy that can be measured in terms of photon count. Again, each peak corresponds to a different spacing d of planes in the crystal.

The novel technique described here applies energy-dispersive X-ray diffraction (EDXRD) in a back-reflection geometry, i.e. with 2θ close to 180°. An insensitivity to the sample morphology follows in part from this geometry. Three key characteristics of the method and apparatus for performing the novel technique are:

1. Detection of X-ray photons diffracted by the sample such that the 2θ diffraction angles of the detected photons are all close to 180°. The acceptable range of angles depends on the details of the implementation. The method does not require measurement or knowledge of the specific angles of the detected photons.

2. 6l Resolution of the energies (or wavelengths) of the diffracted photons, or knowledge of their energies by some means. This could be achieved with an energy- dispersive detector, such as a silicon drift detector, or any type of X-ray spectrometer such as a wavelength-dispersive spectrometer.

3. The diffraction angle is substantially fixed. Therefore in order to access a range of crystal d-spacings, the X-ray source should either be a broadband source or a source which can be scanned through a range of energies. Suitable sources include, but are not limited to, X-ray tubes and synchrotron sources.

Where the source can be scanned through a range of energies, in principle the detected energy (wavelength) might be implicitly resolved, without an energy-resolving detector. In practice the energy-resolving detector is nonetheless useful.

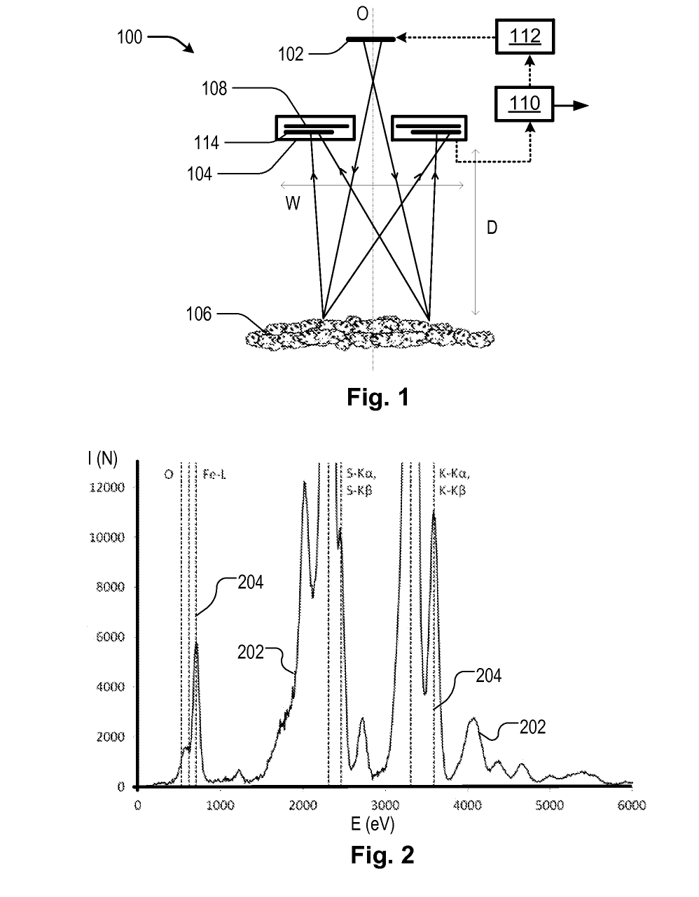

FIG. 1 shows one exemplary apparatus 100 for use as an instrument performing back-reflection energy-dispersive XRD. The instrument 100 includes an X-ray source 102, and a detector assembly 104 facing a sample 106 positioned at a distance D from the detector assembly. The instrument in this example further include a controller 110 and a source driver 112. The source 102 is configured to apply an X-ray beam onto sample 106 with a range of angles, dictated by a collimator 108. Detector assembly 104 is largely circularly symmetric, so that the collimator is an annular shield of metal or other material suitable for blocking the X-rays, except in a central aperture lying on an optical axis 0.

Also within detector assembly 104 is an energy dispersive detector 114 which may also have an annular form, so as to detect radiation diffracted back from the sample. Specifically, radiation is detected with a range of diffraction angles 20 that lie close to 180°, within limits set by the geometry of the source, the collimator, the detector and the sample. Note that diffracted radiation returning at exactly 180° are not generally detected because they return through the aperture in the detector and toward the source. The diffracted radiation detected by the detector may have a diffraction angle greater than 155°, for example, or greater than 160°.

It is understood that FIG. 1 shows just one possible configuration of the source, the sample and the detector, while quite different arrangements are possible. For example, the X-ray source 102 may also be co-planar with the detector 114, or it may lie in front of the detector. The collimator and detector do not need to be within the same assembly 104. Use of an annular detector is not essential, but is advantageous in order to collect most or all of the complete Debye-Scherrer diffraction rings. The detector 114 can instead be a conventional detector mounted to one side of the X-ray source, or a number of separate detectors arrayed around the axis O. Other configurations are possible, such as an annular source with a central aperture, behind which sits a detector (i.e. inverting the roles of the source 102 and detector 114 in FIG. 1). Some of these configurations may be difficult to achieve in practice because of the need to accommodate the X-ray source and the detector in relatively close proximity.

For certain applications it may be desirable to control the width of the X-ray beam footprint on the sample. For example, the user may wish to analyze a restricted portion of the sample. In other cases, a large footprint may be desirable in order to ensure that a sufficient number of crystallites are illuminated so that the crystallite orientations are effectively randomized. The illumination width could be controlled with a variable-aperture collimator 108, or by changing the distance between the instrument and sample (within limits set by the angular requirements).

In all cases, the design is made such that the geometrical configuration of the source, sample and detector restricts the detected radiation to that with 2θ close to 180°. Some tolerance either side of 180° is available, however, because around 2θ=180° the function sinθ) in the Bragg equation is only slowly varying with θ.

Use of currently available energy-dispersive detectors gives limited energy resolution, although future technological developments may improve on currently available detectors. Higher spectral resolution can be achieved through the use of an X-ray monochromator (not shown) positioned either between the source 102 and the sample 106, or between the sample 106 and the detector 114. In the latter position, such an arrangement would conventionally be called an X-ray spectrometer. Many different designs of X-ray monochromators and spectrometers are possible. However, the arrangement should satisfy the three characteristics listed above, in order to achieve insensitivity to the sample morphology.

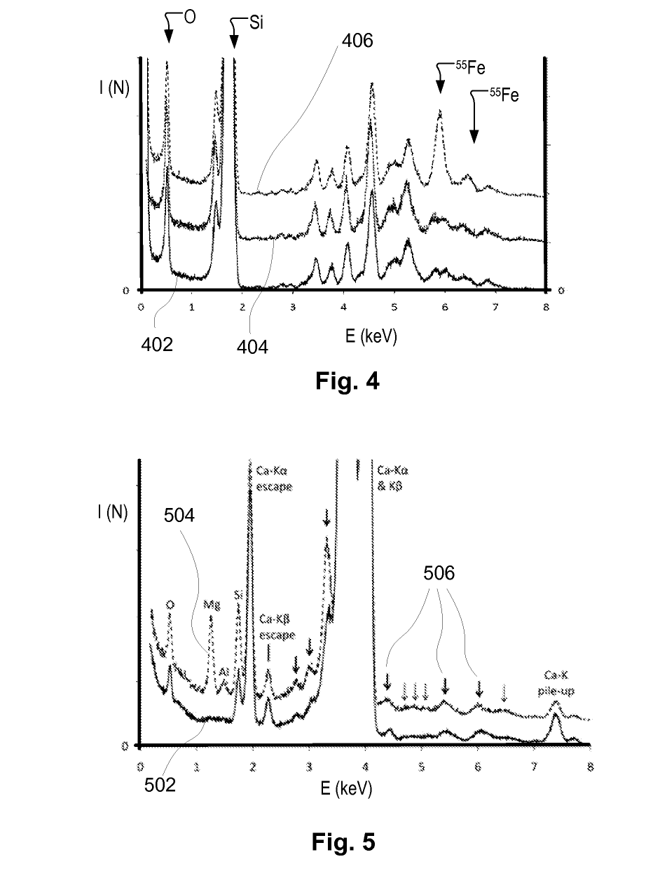

By ensuring a minimum distance (D>=Dₘᵢₙ)between the sample 106 and the detector 114, only those photons which diffract at angles close to 180° are registered by the detector. Since each photon travels back along its incident path (approximately), the distance between the detector and the interaction point on the sample becomes irrelevant. By extension of this argument, it is also irrelevant if different parts of the sample lie at different distances to the detector. As described in the article of reference 1, detailed analysis and ray-trace modeling shows that, for an angular range limited to 2θ 160° to 180°, dependent on the details of the implementation, the technique retains quite remarkable insensitivity to sample morphology. This insensitivity has also been demonstrated in proof-of-principle experiments, which will be illustrated further below with reference to FIG. 4.

In summary, therefore, a method of inspection of a sample comprises irradiating the sample with X-rays from a source position at a range of wavelengths, and detecting peaks in a spectrum of radiation diffracted by the sample in a direction substantially opposite to the direction of irradiation. By using only those photons which have been diffracted through angles close to 180°, together with detection of the energy of the photons, the novel technique can reveal crystal structure with insensitivity to sample morphology. For any given instrument configuration, the range of angles can be restricted within a desired range around 180° by ensuring a certain minimum distance between the sample 106 (more precisely, the nearest point on the sample) and the part of the instrument nearest to the sample. (X-ray source 102 and/or the detector 114). The required minimum distance depends on the details of implementation and the desired energy resolution, as described in Reference 1 mentioned above. If this minimum distance is not achieved, then the diffraction peaks in the measured spectrum will be unduly broadened. For reasons explained in more detail in Reference 1, the extent of such ‘geometric broadening’ is only weakly dependent on the divergence (angular spread) of the primary beam. For a configuration such as the one shown in FIG. 1, the minimum distance Dₘᵢₙ can most usefully be expressed as a minimum ratio of the sample-detector distance D to width or diameter W of (an active area of) detector 114. The ratio D:W may be for example as small as 1.1, though larger ratios such as 1.33, as in the geometry described in Reference 1, or even greater may be preferred. This ratio serves to ensure that the spectral resolution is limited by the detector (for a silicon drift detector) rather than by geometric broadening. For the same instrument configuration, a substantially larger ratio would make a negligible difference to the spectral resolution but would give substantially lower count rates at the detector. Thus, in this type of instrument configuration and using commonly-available detectors, a distance D of approximately 20 mm is optimum. The distance between the sample and detector(s) in conventional angle-dispersive XRD instruments is normally markedly greater, often more than 100 mm. As the strength of diffraction signals falls with the square of the distance D, the fact that the detector can be positioned closer to the sample than in most prior instruments allows greater signal strength for a given source power, or reduced source power for the same signal strength. The distance to the source may be less than 100 mm, less than 70 mm or less than 50 mm. For an instrument configuration designed to achieve significantly higher spectral resolution than obtainable with a silicon drift detector as the only energy-dispersive element, the range of angles close to 180° should be more restricted in order to reduce geometric broadening. For example, if the X-ray source in FIG. 1 is replaced with a combined source and X-ray monochromator, mounted behind the same detector, then the sample-detector distance D must be increased so that the angular range is smaller. Geometric broadening can be substantially reduced even for relatively modest increases in the distance D. For example, if D is increased from 20 mm to 30 mm, the achievable spectral resolution is markedly improved, assuming suitable monochromator resolution. The appropriate value of D can be calculated using the method outlined in Reference 1. Whatever the instrument design, increasing the distance to the sample will reduce the range of angles closer and closer to 180°, and will reduce the geometric broadening.

Suppression of X-Ray Fluorescence Peaks

In addition to the X-ray diffraction, the irradiation with X-rays can give rise to X-ray fluorescence (XRF) in many samples. In these cases, XRF peaks will appear in the detected X-ray spectrum alongside peaks due to diffraction. The XRF peaks yield information about the elemental composition of the sample, and this information can be used to complement the information derived from X-ray diffraction.

While the presence of XRF peaks in the detected spectrum may in some instances be beneficial to the analysis of the sample, these peaks tend to be considerably more intense than the diffraction peaks, and may overlay and obscure them. In these cases, the presence of XRF peaks is likely to be detrimental to the analysis of the sample. Measures for selectively suppressing the XRF peaks in order to reveal hidden diffraction peaks are presented below. It is found that the energy of the XRF peak(s) for any given element is characteristic of that element, and this can help to distinguish XRF and XRD peaks.

In conventional, angle-dispersive XRD, XRF from the sample contributes to the background signal, rather than producing peaks which may be confused with diffraction peaks. There are methods for suppressing the fluorescence signal in conventional XRD, but these are distinct from the method described herein.

To demonstrate the suppression of XRF peaks, some simulations have been performed. These simulations use the well-validated ray-trace Monte Carlo model PoDFluX, as described in an article Graeme M. Hansford, “PoDFluX: a new Monte Carlo ray-tracing model for powder diffraction and fluorescence”, Rev. Sci. Instrum., 80, 073903 (2009) [Reference 2]. The ‘sample’ for these simulations consists of the mineral Jarosite, which has the chemical formula KFe₃(SO₄)₂(OH)₆. Note that the same method can be applied to samples consisting of other minerals or mixture of minerals (or, more generally, crystalline substances).

FIG. 2 illustrates in trace 202 a simulation of the detected spectrum of a Jarosite sample for an instrument configured as shown in FIG. 1, with a tube excitation voltage of 7.1 kV and a current of 0.2 mA, and for a data acquisition period of one minute. Broadly speaking, using an X-ray tube with excitation voltage 7.1 kV can yield broadband X-rays with energies up to 7.1 keV. Suitable X-ray tubes are readily available. In FIG. 2, the vertical axis is scaled to emphasize the diffraction peaks, with the result that some of the XRF peaks, marked with dotted lines 204 etc., are off-scale. The XRF peaks are marked with dotted vertical lines, all other peaks in the spectrum are due to diffraction. The strength of the S-Kα, S-Kβ, K-Kα, and K-Kβ peaks means it is not possible to determine whether there are diffraction peaks lying at the same or similar X-ray energies.

The range of energies (wavelengths) emitted by an X-ray tube type of source is limited by the voltage at which the tube is energized. This can be used as the basis of a method to suppress XRF peaks and allow better detection of XRD phenomena. As an example, we consider the sulfur, S, and potassium, K, XRF peaks in the spectrum of Jarosite. Taking the example of potassium, the Kα, and Kβ peaks occur at the energies 3313 and 3590 eV respectively. However, these fluorescence peaks are only excited if there are X-ray photons incident on the sample with energies greater than 3607 eV, the K-edge absorption energy of potassium. If the X-ray tube excitation voltage is set just below this, say to 3.6 kV, none of the photons incident on the sample can have sufficient energy to excite K fluorescence. The X-ray source will emit Bremsstrahlung photons with energies up to 3.6 keV, and so diffraction peaks which would otherwise be obscured by the K fluorescence will nevertheless appear in the spectrum. This assertion is demonstrated by the simulations shown in

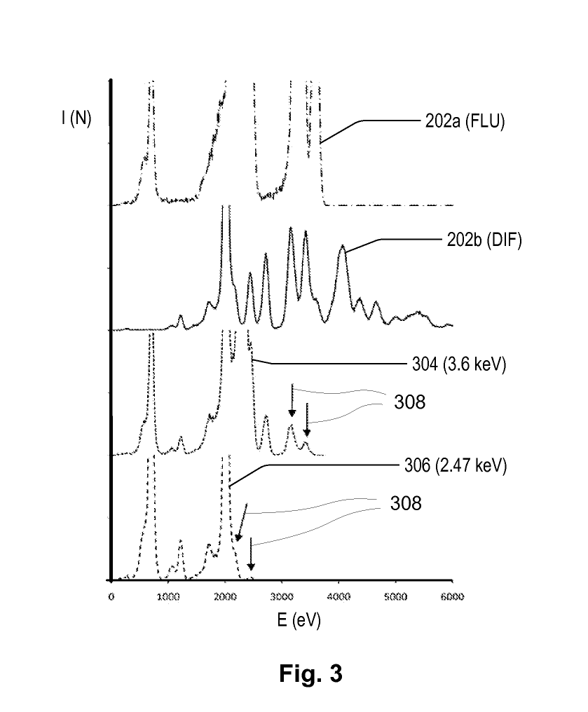

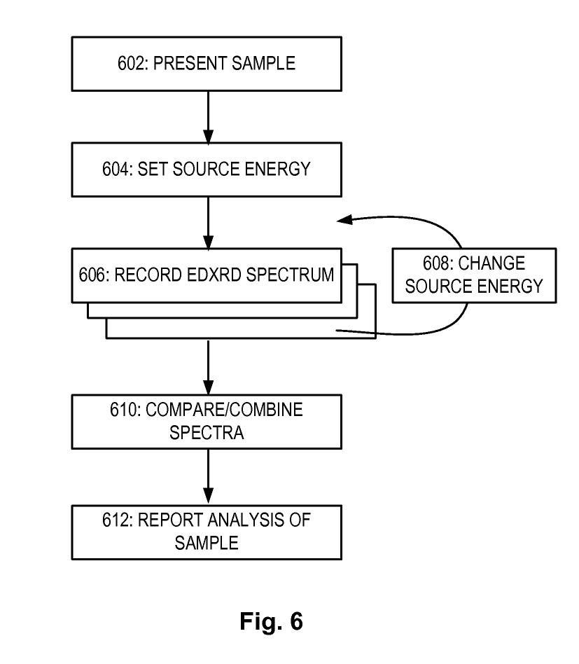

FIG. 3. The application of these observations in a practical method will be described further with reference to FIG. 6. If an X-ray source other than an X-ray tube is used, for example a synchrotron, the maximum energy of the X-ray photons from the source may be restricted in some other way.

FIG. 3 shows several PoDFluX simulations of spectra of a Jarosite sample for an instrument configured as described in reference 1 and operated with the source energized to different voltage levels. In FIG. 3, spectra have been offset on the vertical axis for clarity, and have had intensity normalization factors applied for ease of comparison. All of the simulations use moderate emission currents in the range 0.2 to 1.0 mA, and each spectrum represents data acquisition for a period of one minute.

The top part of FIG. 3 shows the intensity I detected for a tube excitation voltage of 7.1 kV. As far as the detector is concerned, the measured spectrum would be the same as trace 202 in FIG. 2, but for this illustration the simulated contributions 202a of diffraction (DIF) and 202b of fluorescence (FLU) are plotted separately in order to highlight their contributions to the spectrum in FIG. 2. The trace 304 of FIG. 3 shows the simulated spectrum that would be detected from the same sample for a tube excitation voltage restricted to 3.6 kV, causing the suppression of the K fluorescence. The lower trace 306 of FIG. 3 shows the simulated detected spectrum for a tube excitation voltage restricted to 2.47 kV, causing the suppression of both K and S fluorescence. The arrows 308 in FIG. 3 indicate diffraction peaks which are revealed by suppression of K and S fluorescence by tuning the X-ray tube excitation voltage below the excitation energies.

Another way to minimize overlap of XRF and XRD signals is to use a more energy-selective detection and/or irradiation arrangement. As already mentioned, tunable monochromators are available which allow very narrow bands of wavelengths to be selected.

Experiments

Some experiments have been conducted to demonstrate feasibility of the novel method, and in particular to confirm that it is insensitive to sample morphology. These have been performed using an experimental apparatus modeling the apparatus of FIG. 1. A CCD detector was used that is position-sensitive, as well as energy-dispersive, but the position information was not used except to delimit a region-of-interest on the CCD. This allowed experimentation with the angular restriction requirement of the back-reflection EDXRD method. A light-blocking filter comprising a 15 μm thick foil of aluminum was used to prevent light from the X-ray tube filament from reaching the CCD which is sensitive to visible light as well as the desired X-ray wavelengths. Such a filter can be used if necessary in a practical instrument, depending on the type of detector. This filter heavily attenuates X-rays in the range 1.56 keV (the Al-K absorption edge) to ˜3 keV, and so diffraction peaks in this range have very low intensity. Depending on the details, this filter can be much thinner or eliminated altogether in alternative configurations.

FIG. 4 shows the intensity spectra 402, 404 and 406 obtained using a pressed-powder pellet of quartz mounted at three different positions and orientations. This type of sample is prepared in the conventional manner for powder XRD. The sample positions for each trace are:

402: a nominal position about 70 mm from the detector (402),

404: a position 28 mm further away from the X-ray source, and

406: the nominal position but rotated away from the detector by 45°.

In FIG. 4, the Si and O fluorescence peaks are labeled as are two peaks due to the inadvertent exposure of an ⁵⁵Fe calibration source. All other peaks are due to diffraction from quartz. The three graphs have been offset on the vertical scale for clarity. The graph for 28 mm displacement of the sample (spectrum 404) is plotted on a magnified intensity scale, for ease of comparison. It will be seen that the three graphs in FIG. 4 show a very high degree of correspondence, after allowing for the reduced intensity when the sample was positioned further from the source. It should be emphasized that these experimental changes of position and orientation represent movements of the sample of a size which conventional XRD methods would be completely unable to cope with. Even diffractometry methods which are designed to allow some degree of sample morphology and surface roughness cannot accommodate sample movement of this magnitude. Such a method is the parallel-beam diffractometry described by B. B. He, in “Two-Dimensional X-Ray Diffraction”, John Wiley & Sons, New Jersey (2009) [Reference 3].

FIG. 5 illustrates another experiment that confirms that the analysis of a whole rock specimen is feasible, that is without preparation of a special powder sample. A piece of limestone, chosen for its simple mineralogy, was mounted in a test chamber with the experimental apparatus described above with reference to FIG. 4. This sample of limestone consists mainly of calcite, CaCO₃, possibly with minor amounts of dolomite, CaMg(CO₃)₂. The rock was not positioned at a precisely-known distance from the source, and indeed its irregular surface would defeat any attempt to do so. The spectrum of the limestone was compared with the spectrum of a pressed-powder pellet of calcite, that is to say with a sample prepared as for conventional XRD.

In FIG. 5, solid trace 502 shows the back-reflection EDXRD spectrum of the calcite pressed-powder sample while solid trace 504 is the spectrum of a whole rock limestone sample (dotted trace 504). The traces 502, 504 in FIG. 5 have been offset on the vertical scale for clarity. The fluorescence and associated peaks of various elements are labeled with their chemical symbols, while the diffraction peaks are marked with arrows 506. Comparing the two traces, one can see some minor differences, notably the presence of a Mg fluorescence peak in the limestone data, probably indicative of dolomite. However, one can also see that the diffraction peaks seen in the prepared calcite spectrum are reproduced in the limestone rock spectrum. This sample would benefit significantly from the suppression of the Ca-K fluorescence peaks by the method described herein. The peaks marked as ‘escape’ peaks are detector artifacts associated with the Ca-K fluorescence peaks, and these would also be suppressed.

Methods & Applications

The instrument of FIG. 1 can be provided in any suitable form. The fixed back-reflection geometry permits a particularly compact and robust construction, and may be particularly suited for implementation as a portable, even hand-held device. In this way, the instrument can be presented to samples where they lie, be that in the ground, in a museum. It may be mounted on a probe for exploration of an extra-terrestrial body. Further discussion of such application is contained in

Reference 1.

FIG. 6 is a flowchart illustrating the main steps in a measurement technique using the principles described above. Operation of the apparatus and analysis of the results can be automated as desired, by computer programming, for example by programming a computer within controller 110. A method which includes the suppression of XRF signals is illustrated by the flowchart of FIG. 6.

In FIG. 6, step 602 involves presenting the sample to the instrument at a distance that is not critical, but is greater than or equal to a prescribed minimum distance (D>=Dₘᵢₙ). At 604 a value of the source energy is set within the source driver 112, either manually or under computer control. At 606 a spectrum of the back-reflected radiation (i.e. radiation diffracted with angle 180° or so) is recorded from the sample. As explained with reference to FIG. 3, there can be advantages in setting a lower energy, to avoid exciting certain fluorescence peaks. On the other hand, a higher energy (shorter wavelength) may be required to see certain diffraction peaks (certain crystal spacings d). Therefore, at 608 the source energy is increased or decreased to a new setting, and step 606 repeated to record another spectrum. The steps 608 and 606 are repeated until a full desired set of spectra have been recorded.

The settings may be numerous or few. They may be the same for all samples, or they may be selected in accordance with the fluorescence characteristics of materials anticipated to be in the sample. The energy settings may alternatively or in addition be selected adaptively, based on fluorescence peaks observed in the first recorded spectra. For example the first setting may be a maximum energy, such as 7.1 keV and reduced energy settings such as 3.6 keV and 2.47 keV may be selected based on fluorescence peaks observed in the first recorded spectrum. The selection of energy settings may be by manual control, or may be automated. At 610 the spectra are compared and combined to obtain a full set of diffraction peaks, from which fluorescence signals have been suppressed as much as possible. In a simple implementation, the spectrum for the lowest energy setting is used as the authoritative for energies up to the maximum energy recorded in that spectrum, then the next lowest and so forth. More sophisticated combinations may be designed, for example to substitute values from one spectrum or another specifically in the region of known or expected fluorescence peaks. At 612 the set of crystal plane distances d is reported based on the energies (wavelengths) of the detected peaks, and optionally on the relative intensity of radiation (photon count) in each peak. Other methods to identify and/or quantify the crystalline phases present in the sample may be used, such as comparison with a set of standardized spectra from reference samples, or by comparison with model simulations.

The term ‘wavelength-dispersive’ is conventionally used to refer to spectrometer implementations using monochromators and the like, while ‘energy-dispersive’ is used to refer those where spectral resolution is limited by the resolving power of the detector. The difference is a matter of design choice in the context of the present disclosure. If an X-ray monochromator or spectrometer is used (to achieve greater spectral resolution, for example), the details of the measurement technique will need to be adapted as necessary. For example, if a monochromator is used between the X-ray source and the sample, the monochromator will be stepped through a series of settings in order to scan the X-ray energy (wavelength) and a spectrum will be recorded at each setting. The analysis procedure will also need to be adapted.

While specific embodiments of the invention have been described above, it will be appreciated that the invention may be practiced otherwise than as described. For example, the invention may be implemented partly in the form of a computer program containing one or more sequences of machine-readable instructions for controlling the apparatus to perform a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the spirit and scope of the claims set out below.

References

1. G. M. Hansford, “Back-Reflection Energy-Dispersive X-Ray Diffraction: A Novel Diffraction Technique with Almost Complete Insensitivity to Sample Morphology”, J. Appl. Cryst., 44, 514-525 (2011).

2. Graeme M. Hansford, “PoDFluX: a new Monte Carlo ray-tracing model for powder diffraction and fluorescence”, Rev. Sci. Instrum., 80, 073903 (2009).

3. B. B. He, “Two-Dimensional X-Ray Diffraction”, John Wiley & Sons, New Jersey (2009).

1. A method of inspecting a material sample by X-ray diffraction wherein the sample is irradiated with a beam of X-ray radiation from a source with a range of photon energies, and wherein at least one energy-resolved spectrum is obtained from radiation diffracted substantially back toward the source.

2. A method as claimed in claim 1 wherein said diffraction spectrum is processed to obtain information on the spacing of crystal planes in said sample, said information being substantially independent of sample distance or morphology.

3. A method as claimed in claim 1 wherein a plurality of energy-resolved spectra are obtained using different settings of source energy, whereby at least one of said spectra excludes a fluorescence signal that is present in another of said spectra.

4. A method as claimed in claim 3 wherein said plurality of spectra are processed together to obtain information on the spacing of crystal planes in the sample over a wider range of spacings than can be obtained from any one of the spectra on its own.

5. A method as claimed in claim 1, wherein said sample is not prepared in powder form.

6. An apparatus for use in performing back-reflection energy-dispersive X-ray diffraction to determine characteristics of a material sample, the apparatus comprising:
a source arrangement for irradiating said sample with a beam of radiation at X-ray wavelengths;
a detector for detecting diffracted radiation returning from a sample in a direction substantially back towards said source; and
a processor for resolving the detected radiation into a spectrum of wavelengths.

7. An apparatus as claimed in claim 6 wherein said source arrangement is located behind said detector, such that said beam of radiation passes beside said detector or through and aperture in said detector to reach said sample.

8. An apparatus as claimed in claim 6 wherein said source arrangement comprises a source of X-ray radiation that is controllable to restrict the maximum photon energy of radiation to different selected values.

9. An apparatus as claimed in claim 8 including a controller for automatically controlling said source and said detector to record a plurality of spectra using different maximum photon energies.

10. An apparatus as claimed in claim 9 further comprising a processor for processing said plurality of spectra to obtain from one of said spectra information of diffraction peaks that are obscured by fluorescence signals in another of said spectra.

11. An apparatus as claimed in claim 6 wherein said detector substantially or completely surrounds a path of said beam.

12. An apparatus as claimed in claim 6 comprising an X-ray source, a collimator comprising an aperture for passage of said beam of radiation and an energy-resolving detector adjacent said aperture for receiving said diffracted radiation.

13. An apparatus as claimed in claim 6 comprising an X-ray source, a collimator comprising an aperture for passage of said beam of radiation and an energy-resolving detector substantially or completely surrounding said aperture for receiving said diffracted radiation.

14. A method of X-ray diffraction analysis by detecting spectral characteristics of radiation diffracted by a range of angles close to 180°.

15. A method as claimed in claim 14 wherein said diffracted radiation is selected to have a diffraction angle greater than 155°, for example in the range 160°-180°.
